(19) United States
(12) Patent Application Publication
(10) Pub. No.: US 2016/0027598 A1
(43) Pub. Date: Jan. 28, 2016

(54) TEMPERATURE-DEPENDENT SWITCH WITH INSULATING FILM

(71) Applicant: Thermik Geraetebau GmbH, Sondershausen (DE)

(72) Inventor: René NEUMANN, BADRA (DE)

(21) Appl. No.: 14/803,564

(22) Filed: Jul. 20, 2015

(30) Foreign Application Priority Data
Jul. 22, 2014 (DE) 10 2014 110 260.6

(51) Int. Cl. H01H 37/04; H01H 37/60; H01H 37/52

(52) U.S. Cl. CPC H01H 37/04; H01H 37/52; H01H 37/60; H01H 2205/002

(57) ABSTRACT

A temperature-dependent switch having a housing that comprises a cover part with an upper side as well as a lower part with an inner circumferential shoulder and a circumferential wall above the shoulder, which wall comprises an inner side above the shoulder, has a temperature-dependent switching mechanism arranged in said housing. An insulating film is arranged between the lower part and cover part, which insulating film extends with its peripheral region onto the upper side of the cover part. The wall of the lower part is bent onto the upper side and thus holds the cover part on the peripheral shoulder with the insulating film interposed. Said temperature-dependent switching mechanism, depending on its temperature, produces or opens an electrically conductive connection between two contact areas provided externally on the housing. The cover part exerts a radially outwardly directed pressure onto the inner side of the wall via the insulating film.

### RELATED APPLICATION

This application claims priority to German patent application DE 10 2014 110 260, filed Jul. 2, 2014, which is incorporated herein by reference.

### BACKGROUND OF THE INVENTION

The present invention relates to temperature-dependent switches and in particular to a temperature-dependent switch having a housing comprising a cover part with an upper side and a lower part with an internal circumferential shoulder and a circumferential wall above the shoulder, which wall has an inner side above the shoulder. An insulating film is arranged between the lower part and the cover part, with its peripheral region extending onto the upper side of the cover part. The wall of the lower part is bent onto the upper side and thus holds the cover part on the circumferential shoulder in the lower part with the insulating film interposed. A temperature-dependent switching mechanism is arranged in the housing and depending on its temperature, produces or opens an electrically conductive connection between two contact areas provided externally on the housing.

A switch of this type is known from DE 196 23 570 A1.

The known temperature-dependent switch serves in a manner known per se to monitor the temperature of a device. To this end, it is brought into thermal contact with the device to be protected, for example via one of its outer surfaces, such that the temperature of the device to be protected influences the temperature of the switching mechanism.

The switch, via the connection lines soldered to its external contact areas, is electrically connected in series into the supply circuit of the device to be protected, such that below the response temperature of the switch the supply current of the device to be protected flows through the switch.

The known switch has a deep-drawn lower part, in which an internal circumferential shoulder is provided, a cover part resting on said shoulder. The cover part is securely held on this shoulder by a raised and flanged edge of the lower part.

Since the cover part and lower part are manufactured from electrically conductive material, an insulating film is further provided there between, which film extends parallel to the cover part and is raised upwardly at the side, such that its peripheral region extends as far as onto the upper side of the cover part. The flanged edge, i.e. the bent wall of the lower part, presses onto the cover part with the insulating film interposed, such that the insulating film is clamped between the edge and the upper part and also the peripheral shoulder and the inner side of the cover part.

The temperature-dependent switching mechanism here comprises a spring snap-action disc, which carries the movable contact part, and also a bimetal disc positioned over the movable contact part. The spring snap-action disc presses the movable contact part against a stationary mating contact provided inwardly at the cover part.

The spring snap-action disc is supported by means of its edge in the lower part of the housing, such that the electric current flows from the lower part, through the spring snap-action disc and the movable contact part, into the stationary mating contact and from there into the cover part.

A contact area arranged centrally on the cover part serves as a first external terminal. A contact area provided on the flanged edge of the lower part serves as a second external terminal. It is also possible however to arrange the second external terminal not on the edge, but laterally on the current-guiding housing or on the underside of the lower part.

It is known from DE 198 27 113 C2 to attach what is known as a contact bridge to the spring snap-action disc, said contact bridge being pressed by the spring snap-action disc against two stationary mating contacts provided on the cover part. The current then flows from one stationary mating contact, through the contact bridge, into the other stationary mating contact, such that operating current does not flow through the spring snap-action disc itself.

This design is selected in particular then when very high currents have to be switched, which can no longer be guided without difficulty via the spring disc itself.

In both design variants a bimetal disc which is provided for the temperature-dependent switching function is arranged in the switching mechanism in a force-free state when being below its transition temperature, wherein the bimetal disc is arranged geometrically between the contact part or the contact bridge and the spring snap-action disc.

Within the scope of the present invention a bimetal part is understood to be a multi-layer, active, sheet-like component part formed from two, three or four components connected inseparably to one another and having different coefficients of expansion. The connection of the individual layers formed from metals or metal alloys is achieved in an integrally bonded or form-fitting manner, for example by rolling.

Bimetal parts of this type in their low-temperature position have a first stable geometric conformation and in their high-temperature position have a second stable geometric conformation, between which they snap over depending on temperature in the manner of a hysteresis. With changes in temperature above their response temperature or below their return temperature, the bimetal parts snap over into the respective other conformation. The bimetal parts are therefore often referred to as snap-action discs, wherein they may have an elongate, oval or circular form in plan view.

If the temperature of the bimetal disc now rises beyond the transition temperature as a result of a temperature increase in the device to be protected, the configuration of the bimetal disc thus changes and it thus works against the spring snap-action disc, such that it lifts the movable contact part from the stationary mating contact or lifts the current transfer member from the two stationary mating contacts, such that the switch opens and the device to be protected is switched off and cannot heat up further.

With these designs the bimetal disc is mounted mechanically in a force-free manner below its transition temperature, wherein the bimetal disc also is not used to guide the current.

Here, it is advantageous that the bimetal discs have a long mechanical service life, and that the switching point, that is to say the transition temperature of the bimetal disc, does not change even after many switching operations.

If fewer demands are placed on the mechanical reliability or the stability of the transition temperature, the bimetal snap-action disc may also take on the function of the spring snap-action disc and where applicable even of the current transfer member, such that the switching mechanism comprises only one bimetal disc, which then carries the movable contact part or instead of the current transfer member has two contact areas, such that the bimetal disc not only ensures the closing pressure of the switch, but also guides the current in the closed state of the switch,

In addition, it is known to provide switches of this type with a parallel resistor, which is connected in parallel to the external terminals. This parallel resistor, when the switch is open, takes on some of the operating current and holds the switch at a temperature above the transition temperature, such that the switch does not automatically close again after cooling. Switches of this type are called self-holding switches.

It is further known to equip switches of this type with a series resistor, through which the operating current flowing through the switch flows. A resistive heat, which is proportional to the square of flowing current, is thus produced in the series resistor. If the amperage exceeds an admissible measure, the heat of the series resistor causes the switching mechanism to be opened.

A device to be protected is thus then already switched off from its supply circuit when an excessively high current flow occurs that has not yet even caused the device to be excessively heated.

All of these different design variants can be implemented with the switch according to the invention; in particular the bimetal disc can take on the function of the spring snap-action disc.

Instead of a generally round bimetal disc, a bimetal spring fixed at one end may also be used, which carries a movable contact part or a contact bridge.

However, it is also possible to use temperature-dependent switches that as current transfer member do not have a contact plate, but a spring part which carries the two mating contacts or on which the two mating contacts are formed. The spring part may be a bimetal part, in particular a bimetal snap-action disc, which not only ensures the temperature-dependent switching function, but at the same time also ensures the contact pressure and carries the current when the switch is closed.

A temperature-dependent switch constructed in a manner comparable to that from DE 196 23 570 A1, mentioned at the outset, is known from DE 195 17 310 A1, in which however the cover part is manufactured from a positive temperature coefficient resistor material and may rest, without intermediate positioning of an insulating film, on an internal circumferential shoulder of the lower part, the cover part being pressed onto said shoulder by the flanged edge of the lower part.

The positive temperature coefficient resistor cover is thus electrically connected in parallel to the two external terminals, such that it provides the switch with a self-holding function.

Positive temperature coefficient resistors of this type are also referred to as PTC resistors. They are manufactured for example from semi-conductive, polycrystalline ceramics such as BaTiO3.

In the case of the temperature-dependent switch with contact bridge known from above-mentioned document DE 198 27 113 A1, the cover part is likewise manufactured from positive temperature coefficient resistor material, such that it likewise has a self-holding function. Here, two rivets are arranged on the cover part, the externally arranged heads of said rivets forming the two external terminals, and the internally arranged heads of said rivets cooperating as stationary mating contacts with the contact bridge.

With the known switches, the external contact areas and the electrically conductive parts of the housing still have to be electrically insulated once connection lines have been soldered on.

As insulation and pressure protection, the known switches are therefore often inserted into surrounding housings or protective caps, which provide mechanical and/or electrical protection and are often intended to protect the housing simultaneously against the infiltration of contaminations. Examples of this can be found for example in DE 10 2009 030 353 B3 and DE 197 54 158.

Further, it is known from DE 10 2009 039 948 A1 to cast connection lugs with an epoxy resin.

The use of surrounding housings or terminal caps is often found, however, to be too complex in terms of design and unsatisfactory in respect of the thermal connection to the device to be protected.

The known switches are therefore often provided with an impregnating varnish or protective varnish once the connection lines have been soldered on.

In order to prevent varnish from infiltrating the interior of the housing, the cover part of the switch mentioned at the outset is provided with a bead, via which the cover part enters into the insulating film as the wall of the lower part is flanged. This indeed ensures an improved seal, but in many cases varnish still infiltrates the interior of the housing.

Temperature-dependent switches of this type additionally must have a reliable galvanic separation between the cover part and the lower part, i.e. must have a high insulation resistance which does not break down, not even when high voltages are applied.

### SUMMARY OF THE INVENTION

In view of the above, it is one object of the present invention to overcome or at least to mitigate the above-mentioned problems of the known switch in a structurally simple and economical manner and with simple assembly.

This and further objects are achieved in accordance with the invention with the switch mentioned at the outset in that the cover part exerts a radially outwardly directed pressure onto the inner side of the wall via the insulating film.

The inventor of the present application has specifically found that the problems regarding the tightness of the known switch are to be attributed to the fact that sneak paths for liquids form between the insulating film and the wall of the lower part, such that when the known switch is impregnated with protective varnishes these may creep into the interior of the switch.

Also against other electrical insulation materials, the flanged edge of the lower part does not seal the upper side well enough to ensure that liquid cannot enter the interior of the switch in the event of resinification.

Also when soldering connection lines onto the upper side or the contact area provided there, it cannot be completely ruled out that solder or corresponding liquid will enter the interior of the switch.

These sealing problems mean that the known switches time and time again have functional faults and/or insufficient insulation resistances.

Due to the radially outwardly directed pressure, which is preferably caused as a result of the fact that the cover part and insulating film are inserted into the lower part with oversize so to speak, the switch interior is closed so tightly that the new switches in initial tests in the workrooms of the applicant were already tight following the pressing in of the cover part and passed an insulation resistance test between the cover part and the lower part with 500 VAC.

The fact that such a simple mechanical measure solves the sealing problems so reliably was unexpected, especially since the pressure provided with known switches by the cover part onto the peripheral edge via the insulation film cannot ensure the necessary tightness.

In one embodiment, prior to the assembly of the switch, the cover part has an outer diameter, the insulating film has a thickness, and the wall above the shoulder has a lower inner diameter, wherein the sum of outer diameter and twice the thickness is greater than the lower inner diameter.

Here, it is advantageous that the radially outwardly directed pressure is produced merely by the oversize, which is maintained even under consideration of the tolerance ranges of the individual dimensions. There is no need to apply any external forces in order to deform the switch, which forces would lead to an undesirable deformation of the switch. Rather, the oversize of the inserted component parts is sufficient to produce the pressure.

A particularly good seal of the interior of the housing with respect to infiltrating liquids and also simultaneously an outstanding dielectric strength are achieved when the oversize is in the range from 0.01 to 0.2 mm.

The wall on the inner side thereof may have a circumferential insertion bevel, of which the inner diameter reduces preferably continuously from an upper inner diameter to the lower inner diameter, wherein the sum of outer diameter and double thickness is preferably less than the upper inner diameter.

Here, it is advantageous that the insertion bevel facilitates the assembly of the switch. The cover part and the insulating film can thus be inserted above the insertion bevel into the receiving space formed by the cylindrical wall, which is still raised, and can be aligned, still without mechanical interference, before they are pressed downwardly onto the shoulder.

Further, the wall may enclose a lower cylindrical portion, which directly adjoins the shoulder and over its height has the lower inner diameter, and a conical portion enclosed by the wall may adjoin the lower cylindrical portion and form the insertion bevel, wherein the wall preferably may enclose an upper cylindrical portion, which directly adjoins the conical portion and has the upper inner diameter, wherein the cover part also preferably may have a thickness that corresponds at least to the height of the lower cylindrical portion.

These measures ensure among others a good seal and additionally facilitate the assembly. The cover part and where applicable a spacer ring come to lie in the lower cylindrical portion. When the thickness of the cover part, where applicable together with the thickness of a spacer ring, corresponds to the height of the lower cylindrical portion, a predominantly uniform radial pressure is exerted outwardly over the entire thickness of the cover part.

The upper cylindrical portion enables a particularly simple assembly, because there the cover part and insulating film can be firstly aligned, such that they do not tilt when pressed onto the shoulder or the spacer ring.

The insulating film may consist of polyimides, preferably of aromatic polyimides, such as Kapton®.

Insulating films made of these materials are characterized in that they can be placed well around the end face of the cover part onto the upper side thereof, wherein the necessary dielectric strength is also attained.

An insulating protective film may be arranged on the upper side and extends until below the peripheral region of the insulating film.

With this measure it is advantageous that a protective film is additionally provided from above on the upper side and preferably rests flat on the upper side, i.e. does not produce any undesirable counter pressure wherein the raised wall of the lower part is bent onto the upper side. When this protective film extends until below the peripheral region, a particularly good mechanical seal and electrical insulation between lower part and cover part and also to the outside are ensured to the knowledge of the inventors.

The film here preferably consists of aromatic polyamides, more preferably from Nomex®.

Aromatic polyamides are characterized by a particular dielectric strength.

A protective layer, preferably a protective varnish, may be applied at least to the upper side.

This measure is used following the soldering-on of the connection lines in order to protect the finished, assembled switch against infiltrating oils, etc. during use, where it is wound into the winding of a motor, for example. Here, conventional protective varnishes are used as protective varnishes, as are also used in order to protect printed circuit board assemblies. In the case of the new switch the above-explained oversize ensures that these protective varnishes cannot infiltrate the interior of the switch.

The cover part and/or the lower part may be manufactured from electrically conductive material, wherein the switching mechanism may carry a movable contact part, which cooperates with a stationary mating contact, which is arranged on an inner side of the cover part and cooperates with a contact area arranged on the upper side.

These measures lead to a mechanically very pressure-resistant and easily manufactured switch, wherein the contact area on the upper side of the cover part and the bent edge of the lower part each serve as external terminals of the switch.

The switching mechanism here may have a bimetal part, which carries the movable contact part and thus carries the current passing through the switch.

The bimetal part here may also be a round, preferably circular bimetal snap-action disc, wherein it is also possible to use an elongate bimetal spring fixed at one end as bimetal part.

The switching mechanism may additionally have a spring snap-action disc, which then carries the movable contact part and carries the current passing through the closed switch and in the closed state ensures the contact pressure. In this way the bimetal part is relieved both of the current flow and of the mechanical loading in the closed state, which increases the service life of the switch and ensures that the switching temperature is stable in the long term.

The present invention is particularly suitable for round temperature-dependent switches, which are thus round, circular or oval in a plan view of the lower part, wherein the invention may also use other housing shapes.

The invention is particularly advantageous for temperature-dependent switches in which the lower part and cover part are manufactured from metal, wherein the seal effect by the “oversized” cover part and the insulating film bent onto the upper side can also be used with other materials for lower part and/or cover part.

Even when the electrically insulating effect of the insulating film is not required with certain designs, the sealing function can thus still be used.

Further features and advantages will emerge from the description and the accompanying drawings.

It goes without saying that the features mentioned above and the features yet to be explained below can be used not only in each of the specified combinations, but also in other combinations or in isolation, without departing from the scope of the present invention.

### BRIEF DESCRIPTION OF THE DRAWINGS

Embodiments of the invention are illustrated in the drawings and will be explained in greater detail in the following description. In the drawings:

FIG. 1 shows a schematic sectional illustration in side view a first embodiment of a temperature-dependent switch according to the present invention;

FIG. 2 in an illustration similar to FIG. 1 shows a further embodiment of a temperature-dependent switch according to the present invention;

FIG. 3 shows a schematic side view of a first embodiment of a lower part for the switches illustrated in FIGS. 1 and 2, prior to the bending of the circumferential wall, together with a cover part and an insulating film; and

FIG. 4 in an illustration similar to FIG. 3 shows a second embodiment of a lower part.

### DESCRIPTION OF PREFERRED EMBODIMENTS

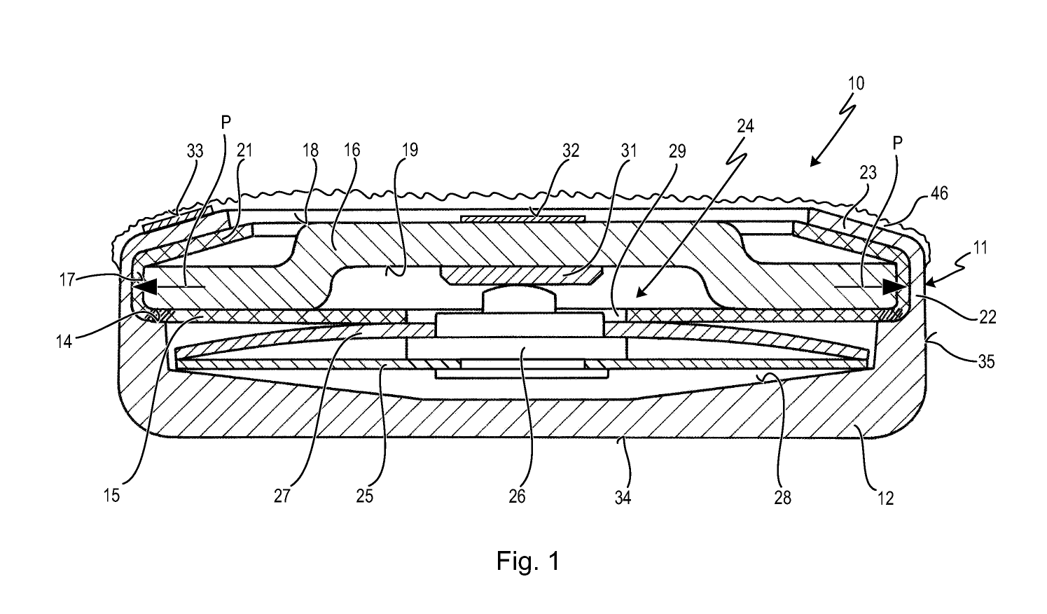

In FIG. 1, a temperature-dependent switch 10 is shown schematically, not to scale, and in lateral section, and comprises a housing 11, which comprises an electrically conductive cup-like lower part 12. An internal circumferential shoulder 14 is provided in the lower part 12, which is circular in plan view, a plate-like electrically conductive cover part 16 resting on said shoulder, with intermediate positioning of an insulating film 15, and closing the lower part 12.

The cover part 16 comprises a peripheral end face 17, which separates an upper side 18 from an inner side 19. The insulating film 15 extends along the inner side 19 and along the end face 17 and reaches with its peripheral region 21 as far as onto the upper side 18.

The lower part 12 comprises, above the shoulder 14, a circumferential cylindrical wall 22 the upper portion 23 whereof is bent onto the upper side 18 and holds the cover part 16 on the lower part 12 with the insulating film 15 interposed.

The insulating film 15 thus ensures an electrical insulation of the cover part 16 with respect to the lower part 12. At the same time, the insulating film 15 ensures a mechanical seal between the cover part 16 and lower part 12.

A temperature-dependent switching mechanism 24 is arranged in the housing 11 of the switch 10 formed by the lower part 12 and cover part 16 and comprises a spring snap-action disc 25, which centrally carries a movable contact part 26, on which a freely placed bimetal snap-action disc 27 sits.

The spring snap-action disc 25 is supported on a base 28 internally on the lower part 12, whereas the movable contact part 26 is in contact, through a central opening 29 in the insulating film 15, with a stationary mating contact 31, which is provided on the inner side 19 of the cover part 16.

In the case of the switch 10 from FIG. 1, two contact areas 32, 33 serve as the external terminals and are formed on the one hand in a central region of the upper side 18 and also on the other hand on the bent portion 23 of the wall 22.

The lower part 12 has a flat underside 34, via which the switch 10 is coupled thermally to a device to be protected.

The temperature-dependent switching mechanism 24 in the low-temperature position shown in FIG. 1 thus produces an electrically conductive connection between the two external contact areas 32, 33, wherein the operating current flows via the stationary mating contact 31, the movable contact part 26, the spring snap-action disc 25, and the lower part 12.

Regions of the underside 34 or of a peripheral surface 35 of the lower part 12 may also serve as external contact area 32.

If, in the case of the switch 10 from FIG. 1, the temperature of the bimetal snap-action disc 27 increases beyond its response temperature via the thermal contact between the underside 34 and the device to be protected, it snaps from the convex position shown in FIG. 1 into its concave position, in which it lifts the movable contact part 26 from the stationary mating contact 31 against the force of the spring disc 25 and thus opens the electric circuit.

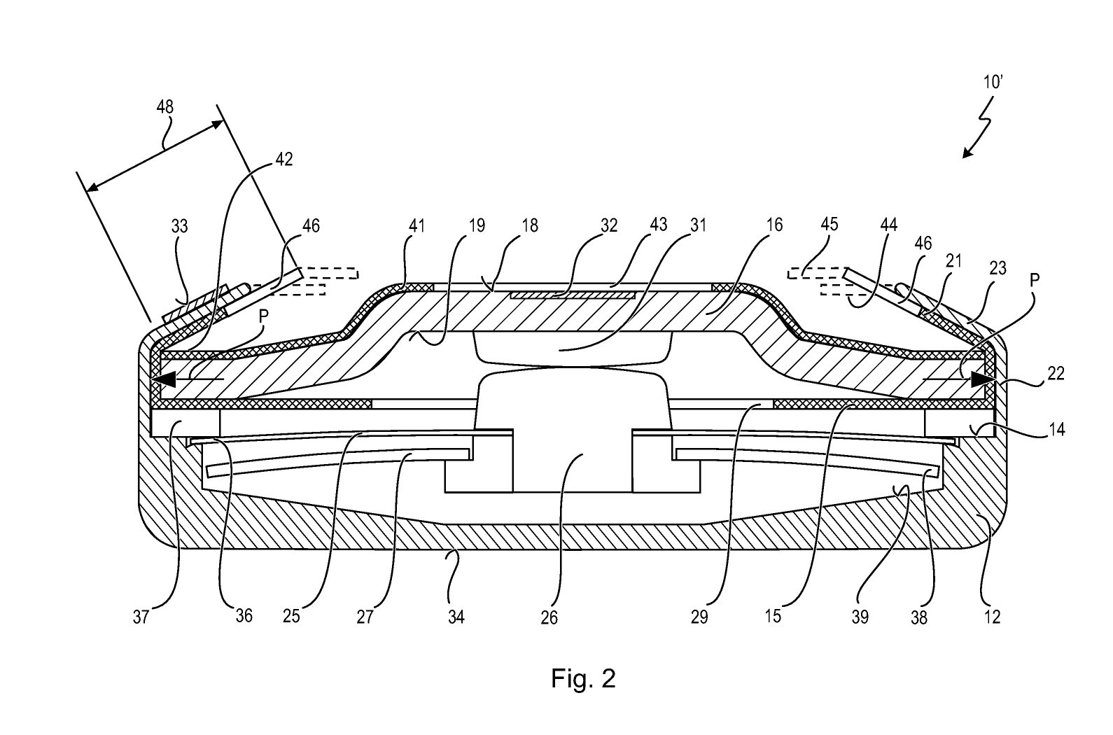

FIG. 2 shows a modification of the switch 10 from FIG. 1 as a further embodiment of the new switch 10′, wherein like reference signs have been used for the switches 10, 10′ for identical design features.

The spring snap-action disc 25 rests here with its edge 36 on the shoulder 14 of the lower part 12 and is held there by a spacer ring 37, on which the insulating film 15 in turn rests, and on this the cover part 16.

The spring snap-action disc 25 again carries the movable contact part 26, which cooperates with the stationary mating contact 31 on the inner side 19 of the cover part 16.

The bimetal snap-action disc 27 is arranged below the spring snap-action disc 25 on the movable contact part 26 and in the closed state shown in FIG. 2 is free from forces.

When the temperature of the bimetal snap-action disc 27 exceeds its response temperature, said bimetal snap-action disc presses via its edge 38 from below against the edge 36 of the spring snap-action disc 25 and in so doing lifts the movable contact part 26 from the stationary mating contact 31.

If the temperature of the bimetal snap-action disc 27 falls below its return temperature, it presses via its edge 38 against a wedge-shaped shoulder 39 running around internally in the lower part 12, such that the spring snap-action disc 25 jumps back into its second geometrically stable conformation, which is shown in FIG. 2.

In contrast to the switch 10 from FIG. 1, in the case of the switch 10′ from FIG. 2 an insulating protective film 41, for example made from Nomex®, is arranged on the upper side 18 of the cover part 16 and extends via its edge 42 radially outwardly as far as until the insulating film 15. The film centrally leaves free a region 43, through which the contact area 32 can be electrically contacted externally on the upper side 18.

The switch 10′ from FIG. 2 is shown at a stage at which the raised wall 22 of the lower part 12 has not yet been bent fully onto the upper side 18, wherein, for reasons of clarity, the edges 44 and 45 of raised wall 22 and insulating film 15 respectively connecting the left and the right region of FIG. 2 are shown by broken lines. As the portion 23 of the wall 22 is bent further, the insulating film 15 passes further downward onto the upper side 18.

In this way the portion 23 can press the peripheral region 21 of the insulating film 15 and where applicable of the protective film 41 onto the upper side 18, such that an electrical insulation and a mechanical seal between lower part 12 and cover part 16 are achieved that are sufficient to ensure that an applied protective varnish 46, as is indicated in FIG. 1, cannot infiltrate the housing 11 between the lower part 12 and cover part 16.

The cover part 16, in a manner that is yet to be described, exerts a radially outwardly directed pressure onto the inner side of the wall 22 via the insulating film 15, which leads to a particularly good seal of the switches 10 and 10′. The pressure is indicated in FIGS. 1 and 2 by P.

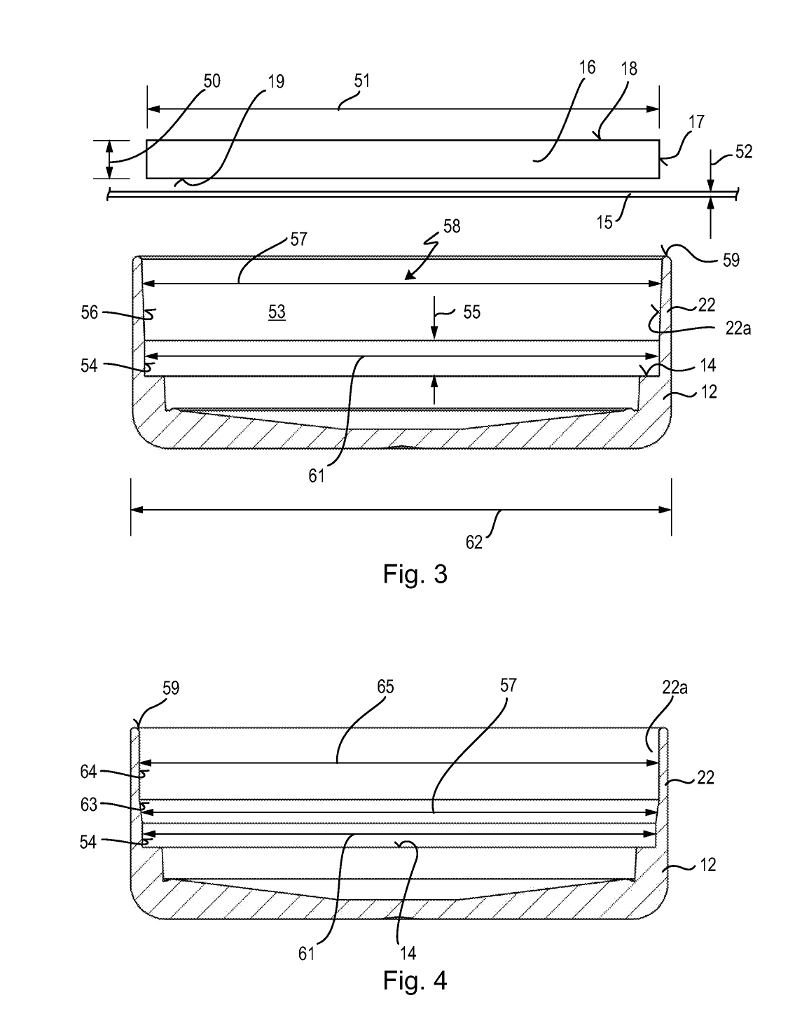

In FIG. 3 a lower part 12 is shown schematically, not to scale, and in a sectional side view, above which an insulating film 15 is shown likewise schematically and not to scale, and a schematically indicated cover part 16 is shown, which here is flat.

The cover part 16 has a thickness 50 and an outer diameter 51, and the insulating film 15 has a thickness indicated at 52. The lower part 12 is shown prior to the insertion of the switching mechanism 24, insulating film 15 and cover part 16, that is to say in its delivered state, in which the wall 22 is not yet bent, but with its circumferential inner side 22a spans an approximately cylindrical receiving space 53, into which the insulating film 15 and cover part 16 and also where applicable the spacer ring 37 still have to be inserted.

The wall 22 in this state on its inner side comprises a lower cylindrical portion 54, which directly adjoins the shoulder 14, and above the shoulder 14 comprises a lower inner diameter 61 and also a height indicated at 55, which corresponds to the thickness 50 of the cover part 16 plus the height of the spacer ring 37 where applicable.

The cylindrical portion 54 of the wall 22 is adjoined by a conical portion 56, of which the inner diameter 57 widens continuously in the direction of an opening 58 to an upper diameter (designated in FIG. 4 by 65), wherein the opening 58 is enclosed there by an end face 59 of the wall 22.

The lower inner diameter 61 in the region of the cylindrical portion 54 is by contrast constant over the height 55.

The relative dimensions are now taken such that the sum of outer diameter 51 of the cover part 16 and the double of the thickness 52 of the insulating film 15 is smaller than the upper inner diameter 65, i.e. the inner diameter 57 in the region of the end face 59, but greater than the lower inner diameter 61, even under consideration of the tolerances. When the cover part 16 rests directly on the shoulder 14 or indirectly via the spacer ring 37, it consequently exerts radially outwardly directed pressure P onto the inner side 22a in the region of the cylindrical portion 54 via the insulating film 19 lying between the inner side 22a and the end face 17.

Reference sign 62 indicates an outer diameter of the lower part 12 in the region of the cylindrical portion 54, which corresponds to the outer diameter of the finished, assembled switch.

When, following the insertion of the switching mechanism 24 into the lower part 12, the insulating film 15 and the cover part 16 are inserted through the opening 58 into the space 53, the inner diameter 57 reducing gradually towards the shoulder 14 thus initially allows an unobstructed insertion. The cover part 16 and insulating film 15, which extends upwardly in the event of insertion along the end faces 17, then exert an ever growing radially outwardly directed pressure onto the inner side 22a of the wall 22 as they are pressed in further, until the cover part 16 via its inner side 19 comes to rest on the shoulder 14 or the spacer ring 37.

The insulating film 15 is in this way clamped between the end face 17 and the inner side 22a of the wall 22, which, once the wall 22 has been bent onto the upper side 18 of the cover part 16, ensures a very good seal of the switch.

As the cover part 16 and insulating film 15 are pressed in, it may be that the wall 22 is pressed slightly outwardly in the region the portion 54. The resultant increases in the outer diameter 62 lie in the tolerance range, however.

The oversize, which has the sum of outer diameter 51 of the cover part 16 and double thickness 52 of the insulating film 15 compared with the inner diameter 61, lies between 0.01 and 0.2 mm under consideration of the tolerances.

In an embodiment the outer diameter 51 ranges from 8.42 to 8.45 mm, the thickness 52 lies between 0.115 and 0.135 mm, and the lower inner diameter 61 ranges from 8.61 to 8.64 mm, i.e. the oversize ranges from at the least 0.01 to at the most 0.11 mm.

Whereas in the embodiment of FIG. 3 the wall 22 by means of the conical portion 56 has a continuous and peripheral insertion bevel from the end face 59 to the lower cylindrical portion 54, the inner side 22a of the wall 22 in the lower part 12 from FIG. 4 again has the lower cylindrical portion 54, which is adjoined by a conical portion 63, which is adjoined by an upper cylindrical portion 64, which extends as far as the end face 59.

The inner diameter 57 in the region of the conical portion 63 increases from the lower inner diameter 61, which is already known from FIG. 3, to the upper inner diameter 65 in the region of the upper cylindrical portion 64.

This lower part 12 thus has a shorter peripheral insertion bevel than the lower part 12 from FIG. 3, otherwise the relative dimensions and operating principles are the same as with the lower part 12 from FIG. 3. The cover part 16 and insulating film 15 here can be inserted initially into the space 53 and aligned before they are pressed along the conical portion 63 into the cylindrical portion 54, which may lead to a facilitation of the assembly.

Therefore, what is claimed is:

1. A temperature-dependent switch comprising a housing having provided externally thereon two contact areas and, a temperature-dependent switching mechanism arranged in said housing, said switching mechanism, depending on its temperature, producing or opening an electrically conductive connection between said two contact areas,
said housing comprising a cover part with an upper side as well as a lower part with an internal circumferential shoulder and a circumferential wall arranged above said circumferential shoulder, said wall comprising an inner side located above said circumferential shoulder,
an insulating film having a peripheral region being arranged between the lower part and the cover part, said insulating film extending with its peripheral region as far as onto the upper side of the cover part,
said wall of said lower part being bent onto said upper side of said cover part, thereby holding said cover part on said circumferential shoulder, said insulating film being interposed between said cover part and said shoulder of said lower part,
wherein said cover part exerts a radially outwardly directed pressure onto the inner side of said wall of said lower part via said insulating film.

2. The switch of claim 1, wherein, prior to the assembly of the switch, the cover part comprises an outer diameter, the insulating film comprises a thickness, and the wall above said circumferential shoulder comprises a lower inner diameter, wherein the sum of said outer diameter and twice said thickness is greater than the lower inner diameter.

3. The switch of claim 2, wherein said sum of said outer diameter and twice said thickness is greater than the lower inner diameter by 0.01 to 0.2 mm.

4. The switch of claim 2, wherein said wall of said lower part comprises an inner side forming a circumferential insertion bevel having an inner diameter that reduces continuously from an upper inner diameter to the lower inner diameter.

5. The switch of claim 4, wherein said sum of said outer diameter and twice said thickness is less than the upper inner diameter.

6. The switch of claim 2, wherein said wall of said lower part encloses a lower cylindrical portion that directly adjoins said circumferential shoulder, said lower cylindrical portion having a height and said lower inner diameter, a conical portion enclosed by said wall adjoining said lower cylindrical portion and forming an insertion bevel.

7. The switch of claim 6, wherein, prior to the assembly of the switch, said wall of said lower part encloses an upper cylindrical portion that directly adjoins the conical portion and comprises said upper inner diameter, wherein said sum of said outer diameter and twice said thickness is less than the upper inner diameter.

8. The switch of claim 6, wherein said cover part has a thickness that corresponds at least to said height of said lower cylindrical portion.

9. The switch of claim 1, wherein said insulating film consists of aromatic polyimides.

10. The switch of claim 1, wherein an insulating protective film is arranged on the upper side and extends until below the peripheral region of the insulating film.

11. The switch of claim 10, characterized in that the protective film consists of aromatic polyamides.

12. The switch of claim 1, wherein a protective layer is applied at least to the upper side.

13. The switch of claim 1, wherein said cover part is manufactured from electrically conductive material.

14. The switch of claim 1, wherein said lower part is manufactured from electrically conductive material.

15. The switch of claim 1, wherein said switching mechanism carries a movable contact part cooperating with a stationary mating contact arranged on an inner side of the cover part and cooperating with a contact area arranged on the upper side.

16. The switch of claim 15, wherein said switching mechanism comprises a bimetal part.

17. The switch of claim 15, wherein said switching mechanism comprises a spring snap-action disc.

18. A temperature-dependent switch comprising a housing having provided externally thereon two contact areas, and a temperature-dependent switching mechanism arranged in said housing, said switching mechanism, depending on its temperature, producing or opening an electrically conductive connection between said two contact areas,
said housing comprising a cover part with an upper side as well as a lower part with an internal circumferential shoulder and a circumferential wall arranged above said shoulder,
said wall comprising an inner side located above said shoulder, said inner side enclosing a conical portion having an inner diameter that reduces from an upper inner diameter to a lower inner diameter,
an insulating film having a peripheral region being arranged between the lower part and the cover part, said insulating film extending with its peripheral region as far as onto the upper side of the cover part,
said wall of said lower part being bent onto said upper side of said cover part, thereby holding said cover part on said circumferential shoulder, said insulating film being interposed between said cover part and said circumferential shoulder of said lower part,
wherein, prior to assembling said switch, the cover part comprises an outer diameter, the insulating film comprises a thickness, and the wall above said shoulder comprises said lower inner diameter, wherein the sum of said outer diameter and twice said thickness is greater than said lower inner diameter.

19. A temperature-dependent switch comprising a housing having provided externally thereon two contact areas, and a temperature-dependent switching mechanism arranged in said housing, said switching mechanism, depending on its temperature, producing or opening an electrically conductive connection between said two contact areas,
said housing comprising a cover part with an upper side as well as a lower part with an internal circumferential shoulder and a circumferential wall arranged above said shoulder,
said wall comprising an inner side located above said circumferential shoulder, said inner side enclosing a conical portion having an inner diameter that reduces from an upper inner diameter to a lower inner diameter, said wall enclosing a lower cylindrical portion with said lower inner diameter and arranged between said circumferential shoulder and said conical portion, prior to assembling, said wall enclosing an upper cylindrical portion of said upper inner diameter and adjoining said conical portion,
an insulating film having a peripheral region being arranged between the lower part and the cover part, said insulating film extending with its peripheral region as far as onto the upper side of the cover part,
said wall of said lower part being bent onto said upper side of said cover part, thereby holding said cover part on said circumferential shoulder, said insulating film being interposed between said cover part and said shoulder of said lower part,
wherein, prior to assembling said switch, the cover part comprises an outer diameter and the insulating film comprises a thickness, wherein the sum of said outer diameter and twice said thickness is greater than said lower inner diameter and less than said upper inner diameter.
